(19) United States
(12) Patent Application Publication
(10) Pub. No.: US 2012/0067490 A1
(43) Pub. Date: Mar. 22, 2012

(54) TIRES WITH HIGH STRENGTH REINFORCEMENT

(76) Inventors: Yann Bernard Duval, Walferdange (LU); Serge Julien Auguste Imhoff, Schrondweiler (LU); Anthony Hardy, Colmar-Berg (LU); Thomas Walter Starinshak, Murrells Inlet, SC (US); Robert Paul Wyszynski, Akron, OH (US); Barry Allen Matrana, Akron, OH (US); James Christopher Kish, Akron, OH (US); Derek Shuttleworth, Medina, OH (US)

(21) Appl. No.: 12/887,683

(22) Filed: Sep. 22, 2010

(51) Int. Cl. B60C 9/18

(52) U.S. Cl. 152/527

(57) ABSTRACT

A pneumatic tire includes a carcass, two sidewalls spaced apart a distance, two beads, a tread disposed radially outward of a crown of the carcass, and a belt structure radially interposed between the tread and the carcass. The belt structure has UT steel reinforcing cords. The cords have filaments with diameters ranging from 0.08 mm to 0.21 mm.

### FIELD OF THE INVENTION

The present invention relates to a pneumatic tire, and more particularly, to reinforcement structures for a pneumatic tire.

### BACKGROUND OF THE INVENTION

Reinforced elastomeric articles are well known. For example, conveyor or like type belts, tires, etc., are constructed with cords of textile and/or fine steel wire filaments or strands. In particular, belts used in pneumatic tires are constructed of up to eight ply layers with the cord reinforcement of adjacent plies being biased with respect to the direction of movement of the tire where it is desired to reinforce in both the lateral direction and the direction of rotation of the tire. Further, cords made of strands of multi-twisted filaments of fine wire with a single strand construction having two or more filaments and a wrap filament thereabout to reinforce the cord structure are known.

In some cases, the reinforcement includes the use of single strand cords of multi-filaments which are not twisted about each other but rather twisted altogether as a bundle or bunch (bunched cord) to simplify the cord construction. Higher fatigue life requirements for composites in tires have resulted in cords with smaller filament diameter, requiring more filaments in the cord to obtain the necessary strength.

Conventional two ply tire belt structures for passenger and light truck tires may have cords of 2×0.255ST and 2+2×0.32-0.40ST, respectively. This designation means one cord of two 0.255 mm diameter filaments and one cord of four 0.32-0.40 mm diameter filaments (with two filaments twisted at a shorter lay length than the other two filaments), respectively. Multi-filament cords such as 2+2×0.32-0.40ST have been found necessary to meet the higher demand for strength of composites in tire belts, such as in light truck applications. Both of these cords are made of super tensile (ST) steel as defined hereinafter. Though cord designs incorporating super tensile (ST) steel have proven effective, there is a continuing need to develop lighter weight cord constructions with improved characteristics, such as higher corrosion propagation resistance and improved tire performance, over conventional high tensile (HT) and super tensile (ST) constructions.

These conventional cord constructions generally have not found use in larger tires, such as off-the-road (OTR) tires. Large OTR tires conventionally use constructions such as 7×7×0.25+1HT and 3×7×0.22HT comprising seven strands each of seven 0.25 mm diameter high tensile (HT) filaments that are twisted together and spiral-wrapped; and three strands each of seven 0.22 mm diameter high tensile (HT) filaments that are twisted together, respectively. One conventional steel cord cable used for ply reinforcement in OTR tires for sizes 36R51 and larger is stranded cord of high tensile (HT) tire cord filament such as 7×19×0.20+1HT cord comprising seven strands each of nineteen 0.20 mm diameter high tensile (HT) filaments that are twisted together and spiral-wrapped.

OTR tires may also be constructed of multiple belts or a single belt with reinforcing cords such as 27×0.265ST or 5+8+14×0.265+1ST. Still, conventional steel cord constructions have breaking load and cable gauge limitations preventing the needed design inch-strength from being achieved for tires larger than 40R57 used on trucks and earthmovers weighing up to and sometimes more than 320 tons. In addition, there is a need to increase the rivet area in the ply and belt, i.e., the space between the cords, for tire sizes of 36R51 and larger so that more rubber may penetrate between the cords during tire manufacture to enhance the quality of calendered treatment by preventing “weak rivet” or “loose coat” (which can result in trapped air in tires).

The higher strength steel alloys have resulted in changes in cord modulus giving rise to the possibility of adjusting the parameters of a tire belt gross load, which depends upon three factors assuming adequate cord to rubber adhesion. The factors are cord modulus, the ratio of cord volume to rubber volume (often expressed as the number of cord ends per inch (epi)), and the angle of cord reinforcement. Further, as the angle of cord reinforcement approaches the direction of rotation of the tire, the support from the reinforcement in the lateral direction moves toward zero. An increase in the above-mentioned two other cord related factors, i.e., the cord modulus and the ratio of cord volume to rubber volume, generally results in an increase of weight for the belt. Added weight can mean added cost, higher rolling resistance, and lower fuel economy of a tire. Simply using lighter cords with a lower modulus does not solve the problem because, even though they have lower weight, the lower cord modulus must be offset by increasing the ratio of cord to rubber volume. This increase in cord volume is limited by the physical size of the cord and the resulting spacing between the cords, which governs the amount of rivet, i.e., the ability of the rubber to penetrate between the cords for good cord to rubber adhesion.

### DEFINITIONS

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). Dtex means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa @ 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa @ 0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa @ 0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa @ 0.20 mm filament diameter.

“Tenacity” is stress expressed as force per unit linear density of the unstrained specimen (gmAex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa @ 0.20 mm filament diameter.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### SUMMARY OF THE INVENTION

A pneumatic tire in accordance with the present invention includes a carcass, two sidewalls spaced apart a distance, two beads, a tread disposed radially outward of a crown of the carcass, and a belt structure radially interposed between the tread and the carcass. The belt structure has UT steel reinforcing cords. The cords have filaments with diameters ranging from 0.08 mm to 0.21 mm.

According to another aspect of the present invention, the UT steel reinforcing cords are arranged so as to have from 8 to 20 ends per inch.

According to still another aspect of the present invention, the UT steel reinforcing cords have a 3×4 construction.

According to yet another aspect of the present invention, the UT steel reinforcing cords have a 3×6 construction.

According to still another aspect of the present invention, the UT steel reinforcing cords have a 3×7 construction.

According to yet another aspect of the present invention, the UT steel reinforcing cords have a 4×7 construction.

According to still another aspect of the present invention, the UT steel reinforcing cords have 0.10 mm diameter filaments.

Another pneumatic tire in accordance with the present invention includes a carcass, two sidewalls spaced apart a distance, two beads, a tread disposed radially outward of a crown of the carcass, and a belt structure radially interposed between the tread and the carcass. The belt structure has MT steel reinforcing cords. The cords have filaments with diameters ranging from 0.08 mm to 0.21 mm.

### BRIEF DESCRIPTION OF THE DRAWINGS

FIG. 1 is a schematic representation of a cross section of an example embodiment of a pneumatic tire for use with the present invention;

FIG. 2 is a schematic representation of a partial cross section of a second example embodiment of a pneumatic tire for use with the present invention;

FIG. 3 is a schematic representation of a cross section of an example reinforcing cord in accordance with the present invention;

FIG. 4 is a schematic representation of a cross section of another example reinforcing cord in accordance with the present invention;

FIG. 5 is a schematic representation of a cross section of still another example reinforcing cord in accordance with the present invention;

FIG. 6 is a schematic representation of a cross section of yet another example reinforcing cord in accordance with the present invention;

FIG. 7 is a schematic representation of a cross section of still another example reinforcing cord in accordance with the present invention;

FIG. 8 is a schematic representation of a cross section of yet another example reinforcing cord in accordance with the present invention;

FIG. 9 is a schematic representation of a cross section of still another example reinforcing cord in accordance with the present invention;

FIG. 10 is a schematic representation of a cross section of yet another example reinforcing cord in accordance with the present invention;

FIG. 11 is a schematic representation of a cross section of still another example reinforcing cord in accordance with the present invention; and

FIG. 12 is a schematic representation of a cross section of yet another example reinforcing cord in accordance with the present invention.

### DETAILED DESCRIPTION OF EXAMPLE EMBODIMENTS OF THE PRESENT INVENTION

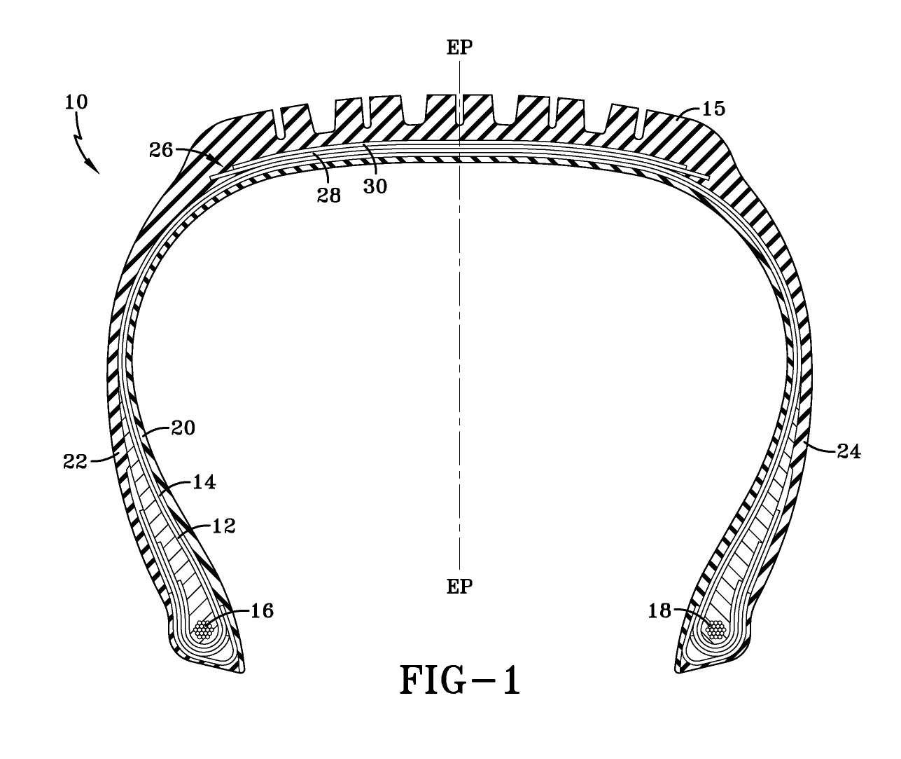

Referring to FIGS. 1 & 2, plies 12, 14 are shown within an example pneumatic tire 10 with a radial carcass wherein like elements have received like reference numerals. The example tire 10 has a radial ply carcass structure when the cords of the carcass reinforcing ply, or plies 12, 14 are oriented at angles in the range of 75° to 90° with respect to the equatorial plane (EP) of the example tire.

Either ply 12, 14 may be reinforced with the metallic cords, rayon, polyester, nylon, or any other suitable reinforcement. The metallic cord reinforced carcass ply 12 or 14 may have a layer of steel cords arranged so as to have from about 8 to about 20 ends per inch (EPI) when measured in a tire circumferential direction at a location having a maximum width MW. For example, the layer of steel cords may be arranged so as to have about 12 to about 16 ends per inch (EPI) at the location having the maximum width MW. In terms of metric units, the steel cords may be arranged as to have from 3 to 8 ends per cm (EPC) when measured in a tire circumferential direction at the location having a the tire maximum width MW. A high number of ends per inch may include the use of a lower diameter wire for a given strength versus a low number of ends per inch for a higher diameter wire for the same strength. Also, use of a monofilament of a given diameter may require more or less ends per inch depending on the strength of the monofilament wire.

The pneumatic tire 10 may have a pair of substantially inextensible annular beads 16, 18, which are axially spaced apart from one another. Each of the beads 16, 18 may be located in a bead portion of the pneumatic tire 10, which has exterior surfaces configured to be complimentary to the beads and retaining flanges of a rim (not shown) upon which the pneumatic tire is designed to be mounted. Plies 12, 14 may be of side-by-side reinforcing cords of polyester, steel, or other suitable material and extend between the beads 16, 18 with an axially outer portion of the carcass structure folded about each of the beads. The carcass ply structure of FIG. 1 comprises two plies 12, 14 of reinforcing material. One or more carcass plies of any suitable material may be employed.

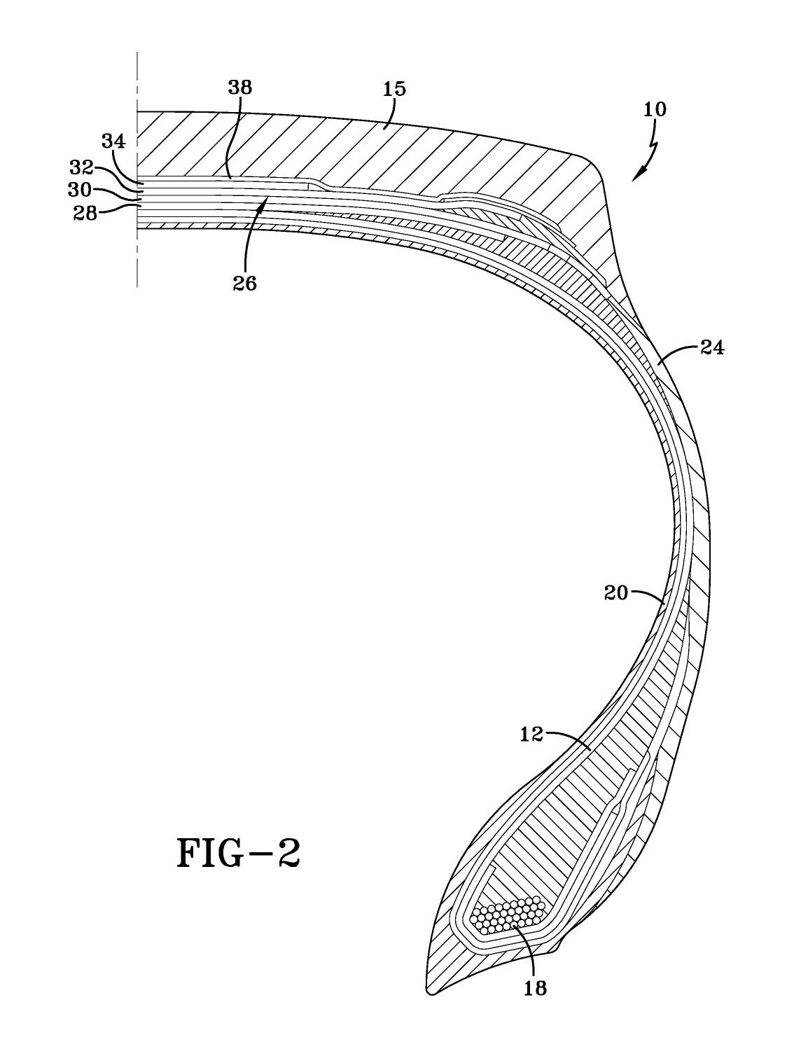

A layer of a low permeability material 20 may be disposed inwardly of the carcass plies 12, 14, and contiguous to an inflation chamber defined by the pneumatic tire 10 and rim. Elastomeric sidewalls 22, 24 may be disposed axially outward of the carcass structure 12, 14. A circumferentially extending belt structure 26 of two layers of belts 28, 30 (FIG. 1), or four layers of belts 28, 30, 32, 34 (FIG. 2), may include steel reinforcing cords 36 as shown in FIG. 3. The belt structure 26 may also include an overlay 38 interposed radially between the belts 28, 30, 32, 34 and the tread 15 (FIG. 2).

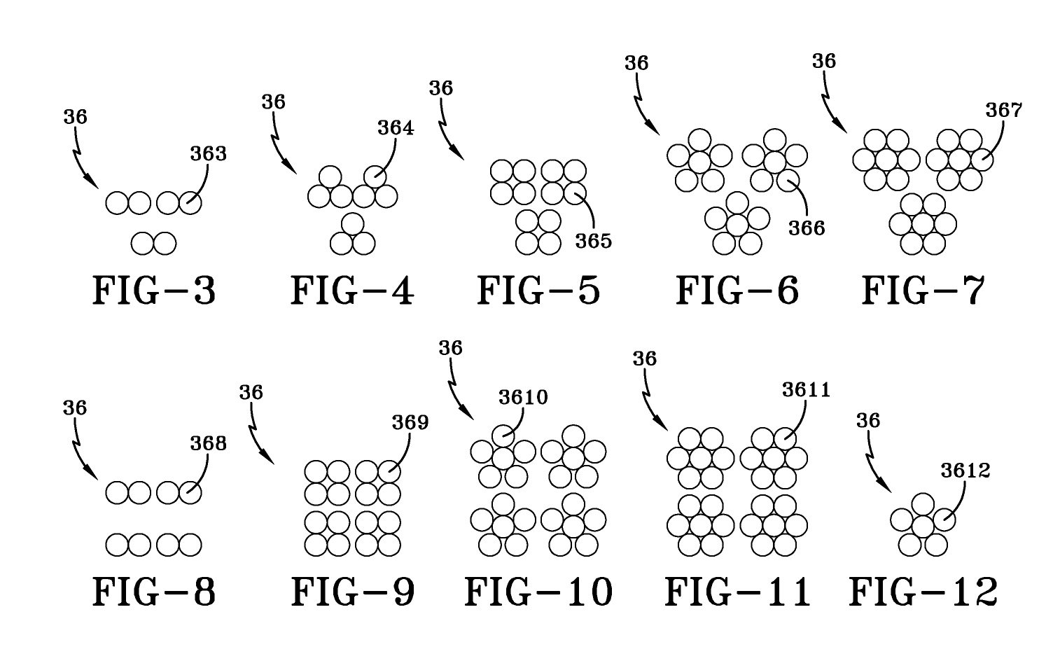

The belt structure 26 of FIGS. 1 & 2 may be characterized by the example cords 36 having filaments of Ultra Tensile Steel (UT) or Mega Tensile Steel (MT) (as defined above) with diameters in the range of 0.08 mm to 0.21 mm and appropriate lay lengths. For example, the cord 36 of FIG. 3 may have a construction of 3×2 filaments 363. The example cord 36 of FIG. 4 may have a construction of 3×3 filaments 364. The example cord 36 of FIG. 5 may have a construction of 3×4 filaments 365. The example cord 36 of FIG. 6 may have a construction of 3×6 filaments 366. The example cord 36 of FIG. 7 may have a construction of 3×7, or 3×⅙, filaments 367. The example cord 36 of FIG. 8 may have a construction of 4×2 filaments 368. The example cord 36 of FIG. 9 may have a construction of 4×4 filaments 369. The example cord 36 of FIG. 10 may have a construction of 4×6, or 4×⅕, filaments 3610. The example cord 36 of FIG. 11 may have a construction of 4×7, or 4×⅙, filaments 3611. The example cord 36 of FIG. 12 may have a construction of 7×, or ⅙, filaments 3612.

One example method of achieving UT strength may be the merging of the process as disclosed in U.S. Pat. No. 4,960,473, which is hereby incorporated by reference in its entirety herein, with a carbon rod microalloyed with one or more of the following elements: Cr, Si, Mn, Ni, Cu, V and B. One example construction may be C 0.88 to 1.00, Mn 0.30 to 0.50, S±0.10 to 0.30, Cr 0.10 to 0.40, V 0 to 0.10, Cu 0 to 0.50, N±0 to 0.50, and Co 0.20 to 0.10 with the balance being Fe and residuals. The resulting rod may then be drawn to a tensile strength equivalent to 4000 Mpa @ 0.20 mm.

Example filaments of 0.30 mm to 0.35 mm diameter UT steel wire may have a cord breaking strength of at least 1,020 Newtons (N), plus or minus 5%. One example structure may have two filaments twisted together with a 16.0 mm lay length with these two filaments twisted at a 16.0 mm lay length together in the same twist direction with two other filaments which are untwisted and parallel to each other when twisted together with the twisted filaments. This example cord, a 2+2 construction (FIG. 5), may be designated as 2+2×30 UT or 2+2×35 UT. The 2+2 construction may exhibit openness and good rubber penetration resulting from the openness. The 0.30 and 0.35 designate the filament diameter in millimeters and the UT designates the material being ultra tensile steel.

The above examples of UT and MT cord structure may perform similar to higher gauge HT and ST steel constructions. Thus, when these example cord structures incorporate filaments having a smaller diameter than those of the HT and ST cord structures, the resulting reduction in gauge material and cost as compared with the HT and ST cord structures results in lighter weight and less costly tires.

Further, for equal filament diameters, the UT and MT cords have higher strength and generally higher fatigue life over the predecessor HT and ST cords. These advantages lead to elastomer products which have less reinforcement material and thus lower weight and cost. Additionally, the life of the product may be increased with the increase in fatigue life of such cords 36 and filaments 363, 364, 365, 366, 367, 368, 369, 3610, 3611, 3612 as shown in U.S. Pat. No. 7,082,978, which is hereby incorporated by reference in its entirety herein.

A parameter which may be varied in a reinforced composite of elastomer is the end count in end per inch (EPI), i.e., the number of cords per unit length in the lateral direction to the direction in which the elastomer is being reinforced. The increased strength of the UT and MT samples may allow a reduction in EPI to achieve comparable strength. Alternatively, cord diameter may be reduced and the end count maintained or increased to achieve comparable strength. Further, a minimum rivet of 0.018″ (0.46 mm) may be maintained to provide proper penetration of elastomers between embedded cords. The penetration may be further enhanced by smaller diameter and simpler (less filaments in a cord) cord constructions made achievable by UT and MT steel filaments.

UT or MT constructions, such as those of FIGS. 3-12, with diameters, for example, of 0.10 mm, provide a lighter weight and less costly alternative for belt constructions of light tires. Further, the reduced weight and cost provide equal to better plant processability (calendering) as well as tire performance greater than conventional constructions. Also, the bi-modulus behavior of the constructions of FIGS. 3-12 (i.e., an initial plateau of the stress-strain curve) provides improved uniformity of belts having such constructions as well as improving footprint and durability performance.

As stated above, a belt structure 26 of UT or MT steel cords 36 in accordance with the present invention produces excellent fatigue performance in a pneumatic tire 10 as well as allowing use of less material in the belt and other parts of the pneumatic tire 10. This structure 24 thus enhances the performance of the tire pneumatic 10, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). An important structural element is the belt structure, typically made up of many cords of fine hard drawn steel or other metal embedded in, and bonded to, a matrix of low modulus polymeric material, usually natural or synthetic rubber. Id. at 207 through 208.

The cords are typically disposed as a single or double layer. Id. at 208. Tire manufacturers throughout the industry cannot agree or predict the effect of different twists of cords of the belt structure on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | | CARCASS | | | | | |
|---|---|---|---|---|---|---|---|
| | LINER | PLY | APEX | BELT | OV'LY | TREAD | MOLD |
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE | X | X | X | | | X | |
| COMFORT | | | | | | | |
| HIGH SPEED | | X | X | X | X | X | X |
| AIR | X | | | | | | |
| RETENTION | | | | | | | |
| MASS | X | X | X | X | X | X | X |

As seen in the table, the belt structure cord characteristics affect the other components of a pneumatic tire (i.e., belt structure affects apex, carcass ply, overlay, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (i.e., twist, cord construction, etc.) of the belt structure of a pneumatic tire is modified with the intent to improve one functional property of the pneumatic tire, any number of other functional properties may be unacceptably degraded. Furthermore, the interaction between the belt structure and the apex, carcass ply, overlay, and tread may also unacceptably affect the functional properties of the pneumatic tire. A modification of the belt structure may not even improve that one functional property because of these complex interrelationships.

Thus, as stated above, the complexity of the interrelationships of the multiple components makes the actual result of modification of a belt structure 26, in accordance with the present invention, impossible to predict or foresee from the infinite possible results. Only through extensive experimentation have the belt structure 26 and cords 363, 364, 365, 366, 367, 368, 369, 3610, 3611, 3612 of the present invention been revealed as an excellent, unexpected, and unpredictable option for a pneumatic tire.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

What is claimed is:

1. A pneumatic tire comprising:
a carcass;
two sidewalls spaced apart a distance;
two beads;
a tread disposed radially outward of a crown of the carcass; and
a belt structure radially interposed between the tread and the carcass, the belt structure having UT steel reinforcing cords, the cords having filaments with diameters ranging from 0.08 mm to 0.21 mm.

2. The pneumatic tire as set forth in claim 1 wherein the UT steel reinforcing cords arranged so as to have from 8 to 20 ends per inch.

3. The pneumatic tire as set forth in claim 1 wherein the UT steel reinforcing cords have a 3×4 construction.

4. The pneumatic tire as set forth in claim 3 wherein the UT steel reinforcing cords have 0.10 mm diameter filaments.

5. The pneumatic tire as set forth in claim 1 wherein the UT steel reinforcing cords have a 3×6 construction.

6. The pneumatic tire as set forth in claim 5 wherein the UT steel reinforcing cords have 0.10 mm diameter filaments.

7. The pneumatic tire as set forth in claim 1 wherein the UT steel reinforcing cords have a 3×7 construction.

8. The pneumatic tire as set forth in claim 7 wherein the UT steel reinforcing cords have 0.10 mm diameter filaments.

9. The pneumatic tire as set forth in claim 1 wherein the UT steel reinforcing cords have a 4×7 construction.

10. The pneumatic tire as set forth in claim 12 wherein the UT steel reinforcing cords have 0.10 mm diameter filaments.

11. A pneumatic tire comprising:
a carcass;
two sidewalls spaced apart a distance;
two beads;
a tread disposed radially outward of a crown of the carcass; and
a belt structure radially interposed between the tread and the carcass, the belt structure having MT steel reinforcing cords, the cords having filaments with diameters ranging from 0.08 mm to 0.21 mm.
